(19) United States
(12) Patent Application Publication
(10) Pub. No.: US 2025/0245056 A1
(43) Pub. Date: Jul. 31, 2025

(54) CONTEXTUAL ENVIRONMENT ANALYTIC ANALYSIS

(71) Applicant: INTERNATIONAL BUSINESS MACHINES CORPORATION, ARMONK, NY (US)

(72) Inventors: Fang Lu, Billerica, MA (US); Hamid Majdabadi, Ottawa (CA); Jessica Nahulan, Markham (CA); Jeremy R. Fox, Georgetown, TX (US)

(21) Appl. No.: 18/428,231

(22) Filed: Jan. 31, 2024

(51) Int. Cl. G06F 9/50; H04L 67/02

(52) U.S. Cl. CPC G06F 9/5038; H04L 67/02

(57) ABSTRACT

A system for collecting and analyzing data to determine a contextual environment of the system, where the contextual environment of the system includes existing software and hardware resources available to the system, employing a matching algorithm to identify additional available software and hardware resources that complement the existing software and hardware resources available to the system, determining a task to be performed on the system, and generating a prioritized list of the additional available software and hardware that complement the system's existing software and hardware resources, the list being ordered based on a degree of relevance with respect to the task to be performed by the system.

### BACKGROUND

Aspects of the present disclosure relate to software and hardware tool contextual environments.

In today's fast-paced and technology-driven world, individuals across industries face the challenge of determining the appropriate software and hardware tools needed to accomplish tasks in specific contextual environments.

### BRIEF SUMMARY

In some embodiments, the method includes collecting and analyzing data to determine a contextual environment of the system, where the contextual environment of the system includes existing software and hardware resources available to the system, employing a matching algorithm to identify additional available software and hardware resources that complement the existing software and hardware resources available to the system, determining a task to be performed on the system, and generating a prioritized list of the additional available software and hardware that complement the system's existing software and hardware resources, the list being ordered based on a degree of relevance with respect to the task to be performed by the system.

Some embodiments of the present disclosure can also be illustrated by a computer program product comprising a computer readable storage medium having program instructions embodied therewith, the program instructions executable by a processor to cause the processors to perform a method, the method comprising collecting and analyzing data to determine a contextual environment of the system, where the contextual environment of the system includes existing software and hardware resources available to the system, employing a matching algorithm to identify additional available software and hardware resources that complement the existing software and hardware resources available to the system, determining a task to be performed on the system, and generating a prioritized list of the additional available software and hardware that complement the system's existing software and hardware resources, the list being ordered based on a degree of relevance with respect to the task to be performed by the system.

Some embodiments of the present disclosure can also be illustrated by a system comprising a memory storing program instructions, and a processor in communication with the memory, the processor being configured to execute the program instructions to perform processes comprising collecting and analyzing data to determine a contextual environment of the system, wherein the contextual environment of the system includes existing software and hardware resources available to the system, employing a matching algorithm to identify additional available software and hardware resources that complement the existing software and hardware resources available to the system, determining a task to be performed on the system, and generating a prioritized list of the additional available software and hardware that complement the system's existing software and hardware resources, the list being ordered based on a degree of relevance with respect to the task to be performed by the system.

### BRIEF DESCRIPTION OF THE DRAWINGS

FIG. 1 illustrates an example computing environment, according to various embodiments of the present invention.

FIG. 2A illustrates an example component for an example method of contextual environment analytic analysis, according to various embodiments of the present invention.

FIG. 2B illustrates an example component for an example method of contextual environment analytic analysis, according to various embodiments of the present invention.

FIG. 2C illustrates an example component for an example method of contextual environment analytic analysis, according to various embodiments of the present invention.

FIG. 2D illustrates an example component for an example method of contextual environment analytic analysis, according to various embodiments of the present invention.

### DETAILED DESCRIPTION

Aspects of the present disclosure relate to contextual environment analytic analysis. While the present disclosure is not necessarily limited to such applications, various aspects of the disclosure may be appreciated through a discussion of various examples using this context.

Neural networks may be trained to recognize patterns in input data by a repeated process of propagating training data through the network, identifying output errors, and altering the network to address the output error. Training data that has been reviewed by human annotators is typically used to train neural networks. Training data is propagated through the neural network, which recognizes patterns in the training data. Those patterns may be compared to patterns identified in the training data by the human annotators in order to assess the accuracy of the neural network. Mismatches between the patterns identified by a neural network and the patterns identified by human annotators may trigger a review of the neural network architecture to determine the particular neurons in the network that contributed to the mismatch. Those particular neurons may then be updated (e.g., by updating the weights applied to the function at those neurons) in an attempt to reduce the particular neurons' contributions to the mismatch. This process is repeated until the number of neurons contributing to the pattern mismatch is slowly reduced, and eventually the output of the neural network changes as a result. If that new output matches the expected output based on the review by the human annotators, the neural network is said to have been trained on that data.

Once a neural network has been sufficiently trained on training data sets for a particular subject matter, it may be used to detect patterns in analogous sets of live data (i.e., non-training data that have not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter will occur.

However, accurate event prediction for some subject matters relies on processing live data sets that contain large amounts of data that are not structured in a way that allows computers to quickly process the data and derive a target prediction (i.e., a prediction for which a probability is sought) based on the data. This “unstructured data” may include, for example, various natural-language sources that discuss or somehow relate to the target prediction (such as descriptions of previous tool usage or task completion by the system), uncategorized statistics that may relate to the target prediction, and other predictions that relate to the same subject matter as the target prediction. Further, achieving accurate predictions for some subject matters is difficult due to the amount of sentiment context present in unstructured data that may be relevant to a prediction. For example, the relevance of many task completion histories, instructions, and other tool related data used to make a prediction may be based almost solely on the sentiment context expressed in the post. Unfortunately, computer-based event prediction systems such as neural networks are not currently capable of utilizing this sentiment context in target predictions due, in part, to a difficulty in differentiating sentiment-context data that is likely to be relevant to a target prediction from sentiment-context data that is likely to be irrelevant to a target prediction. Without the ability to identify relevant sentiment-context data, the incorporation of sentiment analysis into neural-network prediction analysis may lead to severe inaccuracies. Training neural networks to overcome these inaccuracies may be impractical, or impossible, in most instances.

The amount of unstructured data that may be necessary for accurate prediction analysis may be so large for many subject matters that human reviewers are incapable of analyzing a significant percentage of the data in a reasonable amount of time. Further, in many subject matters, large amounts of unstructured data is made available frequently (e.g., daily), and thus unstructured data may lose relevance quickly. For this reason, human reviewers are not an effective means by which relevant sentiment-context data may be identified for the purposes of prediction analysis. Therefore, an event-prediction solution that is capable of analyzing large amounts of structured data, selecting the sentiment context therein that is relevant to a target prediction, and incorporating that sentiment context into a prediction is required.

Some embodiments of the present disclosure may improve upon neural-network predictive modeling by incorporating multiple specialized neural networks into a larger neural network that, in aggregate, is capable of analyzing large amounts of structured data, unstructured data, and sentiment context. In some embodiments one component neural network may be trained to analyze sentiment of unstructured data that is related to the target prediction, whereas another component neural network may be designed to identify lists of words that may relate to the target prediction. As used herein, the terms “word” and “words” in connection with, for example, a “word type,” a “word list,” a “word vector,” an “identified word” or others may refer to a singular word (e.g., “Minneapolis”) or a phrase (e.g., “the most populous state in Minnesota”). For this reason, a “word” as used herein in connection with the examples of the previous paragraph may be interpreted as a “token.” In some embodiments, this list of relevant words (e.g., entities) may be cross-referenced with sentiment-context data that is also derived from the unstructured data in order to identify the sentiment-context data that is relevant to the target prediction. In some embodiments, the multiple neural networks may operate simultaneously, whereas in other embodiments the output of one or more neural networks may be received as inputs to another neural network, and therefore some neural networks may operate as precursors to another. In some embodiments, multiple target predictions may be determined by the overall neural network and combined with structured data in order to predict the likelihood of a value at a range of confidence levels. In some embodiments these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). “Neural network” may also refer to a regression-type neural network, which may have a single output in the form, for example, of a numerical value.

In some embodiments, for example, a neural network in accordance with the present disclosure may be configured to generate a prediction of the probability of a target event (i.e., the event for which a probability is sought in a target prediction) related to a particular subject matter. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without user intervention.

For example, in some embodiments a predictive neural network may be utilized to predict the numerical probability that a particular publicly traded company may realize a profit in a given fiscal quarter. The predictive neural network may be composed of multiple component neural networks that are complementarily specialized. For example, a first component neural network may be specialized in analyzing unstructured data related to the company (e.g., newspaper articles, blog posts, and financial-analyst editorials) to identify a list of entities in the unstructured data and identify sentiment data for each of those entities. One such entity, for example, may be the name of the particular company, whereas another such entity may be the name of the particular company's CEO.

However, the list of entities and corresponding sentiment data may also contain irrelevant entities (and thus sentiment data). For example, one blog post may reference the blog author's business-school teacher. Therefore, a second component neural network may be specialized to review structured and unstructured data and identify a list of relevant entities within the unstructured data. This list of entities may then be cross-referenced with the entities identified by the first component neural network. The sentiment data of the entities identified as relevant by the second component neural network may then be selected.

In this example, the list of entities identified by the second component neural network may be vectorized by a third component neural network. As a result, each entity from the list of entities may be represented by a corresponding word vector, and each feature vector may be associated with corresponding sentiment data. These word vectors and associated sentiment data may be input into a fourth component neural network. This fourth component neural network may be specialized to process the word vectors and sentiment data and output a numerical probability that the particular company will realize a profit in the given fiscal quarter.

In today's fast-paced and technology-driven world, individuals across industries face the challenge of determining the appropriate software and hardware tools needed to accomplish tasks in specific contextual environments. Without a comprehensive understanding of the available resources, individuals often resort to time-consuming and error-prone manual processes to gather information, which can result in inefficiencies and disruptions to workflow. The rapid advancement of technology further complicates the decision-making process, making it difficult for individuals to stay updated with the latest tools that can enhance their productivity. In some instances, a technical solution is necessary that leverages advanced data processing and analysis techniques, such as machine learning and natural language processing, to automatically analyze the user's contextual environment, tasks, and available resources. By providing intelligent recommendations for additional tools, this solution can empower users to make informed choices that align with their specific needs, improving their efficiency and accuracy in completing tasks.

Traditionally, individuals faced with this problem would manually gather information, often relying on previous experience or incomplete knowledge, to make decisions about the tools they require. This process is time-consuming, error-prone, and fails to consider all the pertinent factors that could impact their success. With the rapid evolution of software and hardware technologies, it becomes increasingly challenging for individuals to keep pace with the latest tools that could enhance their productivity.

In some instances, addressing this problem requires a technical solution that leverages advanced data processing and analysis techniques to automatically analyze the contextual environment, tasks to be completed, and available software and hardware resources. By doing so, the solution can provide intelligent recommendations on the additional tools required to successfully accomplish the tasks at hand. Such a solution can improve the functioning of a computer system, streamline decision-making processes, and provide systems with functional environments that speed processes by employing tools that align with the specific needs and the requirements of the contextual environment.

Underlying technologies that can enable this solution include machine learning algorithms, natural language processing, contextual data retrieval, and integration with software and hardware databases. These technologies can be employed to collect, analyze, and interpret data pertaining to the user's contextual environment, tasks, and available resources. By harnessing the power of data analytics and automation, the solution can accurately identify the gaps and requirements, presenting users with tailored recommendations for the tools that will best suit the system needs in a given situation.

A strategy will now be described for obtaining a predicted probability of a target event utilizing a predictive neural network that comprises several specialized neural-network components. In some embodiments the nature of training the neural network may vary based on, for example, the specialization of the component neural networks being trained, the input processed by those neural networks, or the output generated by those neural networks.

For example, a first neural network may be configured to ingest a corpus of data sources related to the subject matter and output a list of “word types” related to the target prediction. These word types may be, for example, entities (e.g., a thing that has its own independent existence; something that exists apart from other things). In an ontological structure, entities may form the “ground level” of the structure (e.g., the terminus from which no branches depend). Entities may be named entities (e.g., John Doe) or standard entities (person). This first neural network can therefore be trained to understand the vocabulary of the particular subject matter, so it can identify, in the corpus of data sources, a list of entities that are relevant to the target prediction. A second neural network, for example, may be trained to identify sentiment context associated with the identified entities in the corpus (e.g., were the entities spoken of in a positive, negative, or neutral manner?). A third neural network may accept the list of entities and convert the entities into vectors, which may, together with the sentiment data, feed into a fourth neural network. This fourth neural network may process the entity vectors and the sentiment data and calculate a probability of the target event occurring. This fourth neural network may therefore be trained in recognizing patterns, among entity data and sentiment data for the particular subject matter, that correlate strongly with predictions for events that are analogous to the target event.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

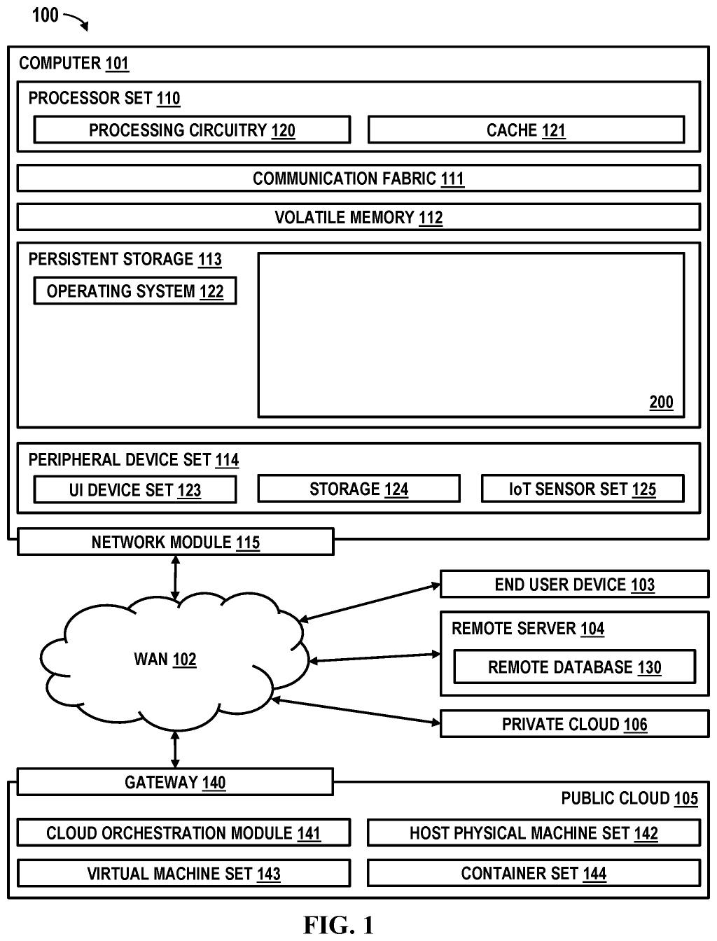

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored. Computing environment 100 contains an example of an environment COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate method 200 in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Organizations often face challenges in determining the appropriate software and hardware tools they need to effectively complete their tasks within a specific contextual environment. This uncertainty leads to inefficiencies, wasted time, and potential disruptions in workflow.

Traditionally, this problem is addressed manually gathering information, often relying on previous experience or incomplete knowledge, to make decisions about the tools they require. This process is time-consuming, error-prone, and fails to consider all the pertinent factors that could impact their success. With the rapid evolution of software and hardware technologies, it becomes increasingly challenging for individuals to keep pace with the latest tools that could enhance their productivity.

Addressing this problem requires a technical solution that leverages advanced data processing and analysis techniques to automatically analyze the contextual environment, tasks to be completed, and available software and hardware resources. By doing so, the solution can provide intelligent recommendations on the additional tools required to successfully accomplish the tasks at hand. Such a solution can significantly reduce the guesswork involved in tool selection, streamline decision-making processes, and empower individuals to make more informed choices that align with their specific needs and the requirements of their contextual environment.

Underlying technologies that can enable this solution include machine learning algorithms, natural language processing, contextual data retrieval, and integration with software and hardware databases. These technologies can be employed to collect, analyze, and interpret data pertaining to the user's contextual environment, tasks, and available resources. By harnessing the power of data analytics and automation, the solution can accurately identify the gaps and requirements, presenting users with tailored recommendations for the tools that will best suit their needs in a given situation.

In some embodiments, a system is disclosed that analyzes a user's contextual environment and the tasks to be completed in order to provide the guidance on the software and hardware that is complementary for the user to complete the tasks.

In some embodiments, the system analyzes the user's contextual environment. In some embodiments, the system determines the tasks the user intends to complete. In some embodiments, the system determines the software and the hardware the user has access to. In some embodiments, the system determines what the additional tools are that the user needs to complete the tasks.

In some embodiments, the disclosed system analyzes a user's contextual environment, tasks to be completed, and available software and hardware resources to provide intelligent recommendations for additional tools needed. For example, the system collects data about the user's contextual environment through sensors and Application Programming Interfaces (APIs), applies machine learning algorithms to extract insights and patterns, determines task characteristics through natural language processing, identifies available software and hardware resources from databases and APIs, and utilizes a matching algorithm to recommend the most suitable tools. In some embodiments, the system continually updates its analysis algorithms and integrates with other components to ensure accurate and personalized recommendations.

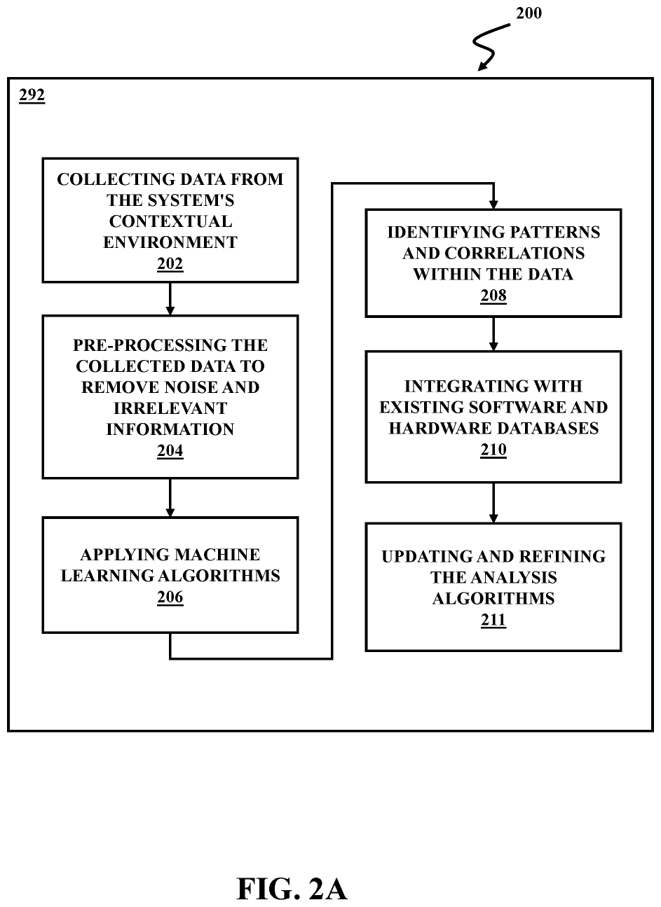

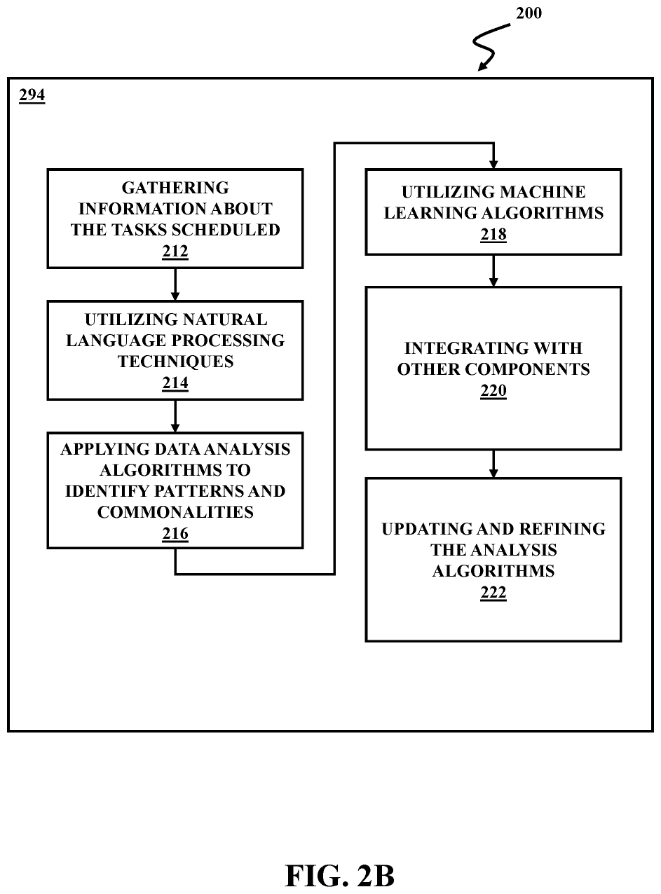

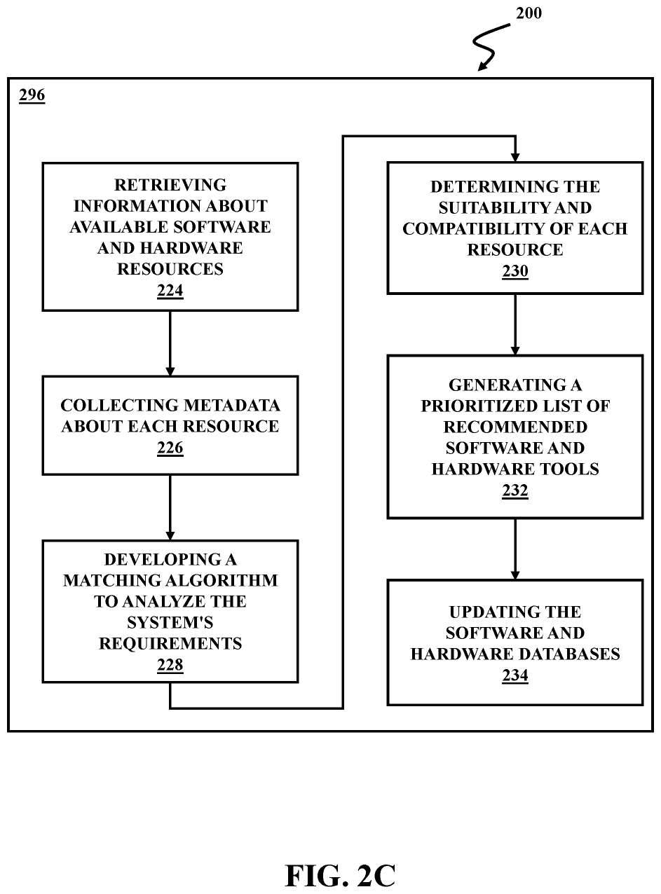

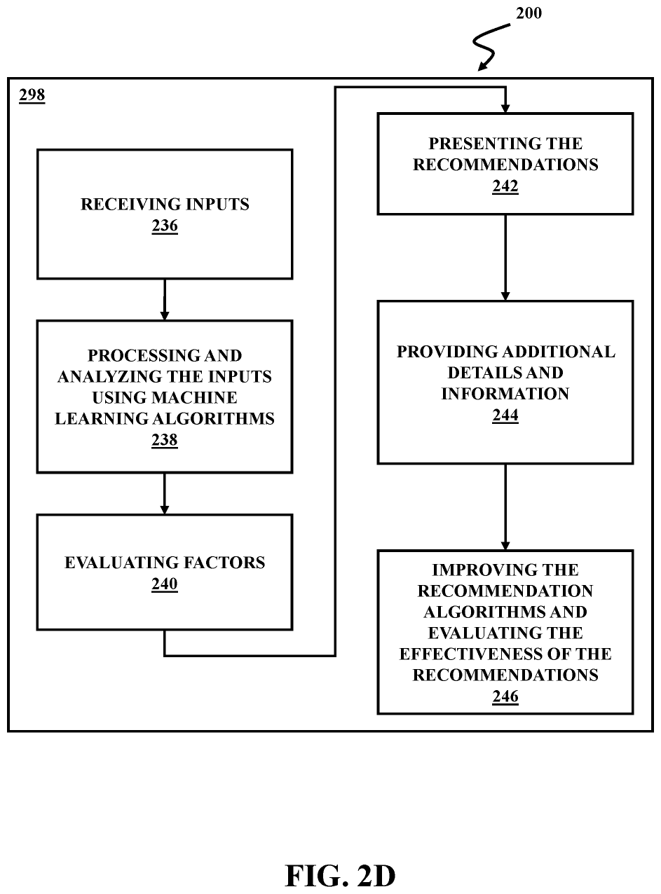

In some embodiments, the components depicted in FIGS. 2A, 2B, 2C, and 2D work collaboratively in example method 200 of contextual environment analytic analysis, with data flowing between the components, to provide an end-to-end solution for determining the appropriate tools needed to complete tasks in a given contextual environment.

FIG. 2A depicts example contextual environment analysis component 292 of an example method 200 that continues in FIGS. 2B, 2C, and 2D. Operations of method 200 may be enacted by one or more computing environments such as the system described in FIG. 1 above. In some embodiments, the example contextual environment analysis component 292 is responsible for gathering and analyzing data related to the system's contextual environment. In some embodiments, the example contextual environment analysis component 292 collects information such as location, connectivity, available software, and hardware resources. In some embodiments, the example contextual environment analysis component 292 utilizes technologies such as sensors, APIs, and data retrieval algorithms to collect contextual data. Machine learning algorithms can be employed to process and analyze this data, identifying patterns and extracting meaningful insights about the system's environment. In some embodiments, a system may be a system tied to a user. For example, the system may be a profile tied to a user, a system used by a user, a collection of computers with a node with a profile for a user, a program on a computer or computer system linked to a user, a blockchain network, and/or another computer system.

Method 200 begins with operation 202 of collecting data from the system's contextual environment using sensors and Application Programming Interfaces (APIs). In some instances, sensors may include motion, location, and environmental sensors. In some instances, sensors may collect data related to movement, location, and environmental conditions. In some instances, APIs provide access to external data sources such as social media, calendar events, and IoT devices. The data gathered from sensors and APIs enables the creation of context-aware experiences by understanding user behavior, preferences, and surroundings. In some instances, data processing techniques, including data fusion and machine learning, may be utilized to refine the context of an application.

Method 200 continues with operation 204 of pre-processing the collected data to remove noise and irrelevant information. In some embodiments, pre-processing collected data may be used to refine and enhance the quality of raw information obtained from sensors and APIs. Pre-processing of data may involve:

Smoothing techniques, such as moving averages and outlier detection, reducing random variations and distortions.

Cleaning steps to address missing data and remove duplicates, ensuring data integrity.

Normalization and standardization to make numerical data compatible for analysis while feature selection and dimensionality reduction streamline relevant variables.

Filtering techniques, including thresholding and domain-specific filtering, to discard irrelevant data points. Temporal and spatial filtering adjusts resolutions and focuses on specific regions of interest. In text data, tokenization, stemming, and stopword removal streamline information.

Verification and validation steps, such as cross-validation, to ensure the accuracy and consistency of pre-processed data.

Method 200 continues with operation 206 of applying machine learning algorithms, such as clustering or classification, to analyze the data and extract meaningful insights. For example, Jessica needs to travel to a client site for a presentation. Based on the collected data and data pattern analysis, the system determines this is a work-related event, and the client site uses Microsoft® technology. Since Jessica has a MacBook®, she needs to bring a MacBook® adapter to present at the client site without any device issues.

Method 200 continues with operation 208 of identifying patterns and correlations within the data to understand the system's contextual environment. In some embodiments, identifying patterns and correlations involves a systematic analysis of refined data, employing techniques such as exploratory data analysis, descriptive statistics, and correlation analysis. In some instances, visual representations like charts and graphs aid in revealing complex relationships, and time-series analysis is employed for temporal data. In some instances, operation 208 may use cluster analysis to group similar data points while machine learning algorithms and association rule mining uncover intricate patterns and relationships. In some instances, dimensionality reduction techniques and statistical testing may reveal the data's underlying structures. In some instances, integration of domain-specific knowledge may augment contextual analysis, aligning identified patterns with the system's environment and activities.

Method 200 continues with operation 210 of integrating with existing software and hardware databases to gather additional information about available resources. In some embodiments, integrating with existing software and hardware databases begins with a clear definition of integration objectives and requirements, followed by a thorough assessment of compatibility between databases. The choice of integration method, such as API integration, database connectors, or middleware solutions, depends on the nature of the databases involved. Data mapping and transformation ensure consistency, while security measures, including encryption and authentication, safeguard sensitive information. Rigorous testing, monitoring, and maintenance are crucial for identifying and addressing issues, ensuring data accuracy, and establishing a reliable integrated system. Documentation of the integration process is essential for future reference and the onboarding of new team members. Overall, successful integration enhances decision-making capabilities and optimizes the utilization of available resources.

Method 200 continues with operation 211 of updating and refining the analysis algorithms based on user feedback and evolving contextual environments. In some embodiments, improvement of analysis algorithms is used to adapt to evolving system needs and changing contextual environments. In some embodiments, updating and refining algorithms based on user feedback ensures that the analytical tools remain relevant and effective. In some instances, user feedback helps to identify the strengths and weaknesses of existing algorithms, guiding the refinement process. Additionally, staying attuned to evolving contextual environments allows for adjustments that accommodate changing trends, technologies, or user behaviors. In some embodiments, iterative approach fosters a dynamic system that can swiftly respond to changing data. In some instances, by actively incorporating user feedback and monitoring contextual shifts, method 200 improves the agility and accuracy of the analysis algorithms, ultimately enhancing the efficiency and accuracy of the analytical tools.

FIG. 2B depicts an example task analysis component 294 of method 200. In some embodiments, the example task analysis component 294 focuses on understanding the scheduled tasks (e.g., tasks the user intends to complete). In some embodiments, the example task analysis component 294 gathers information about the specific requirements, goals, and constraints associated with each task. Natural language processing techniques may be utilized to extract task-related information from textual input or verbal communication. In some embodiments, the example task analysis component 294 works closely with the contextual environment analysis component to understand how the tasks align with their environment and resource availability.

Method 200 continues with operation 212 of gathering information about the tasks scheduled to be completed through user input or data retrieval from other applications.

Method 200 continues with operation 214 of utilizing natural language processing techniques to extract relevant details and categorize the tasks based on their requirements and constraints. Natural language processing (NLP) is a field of computer science, artificial intelligence, and linguistics that, amongst other things, is concerned with using computers to derive meaning from natural language text. NLP systems may perform many different tasks, including, but not limited to, determining the similarity between certain words and/or phrases. One known way to determine the similarity between words and/or phrases is to compare their respective word embeddings. A word embedding (or “vector representation”) is a mapping of natural language text to a vector of real numbers in a continuous space.

Method 200 continues with operation 216 of applying data analysis algorithms to identify patterns and commonalities among the tasks, enabling grouping and organization. In some instances, operation 216 may resemble operation 208.

Method 200 continues with operation 218 of utilizing machine learning algorithms to learn from historical task data and make accurate predictions or recommendations. In some instances, the system may use machine learning algorithms to learn from historical task data to increase the accuracy of models and predictions. In some instances, upon feeding historical data into machine learning models, the algorithms can identify patterns, trends, and correlations within the dataset. Machine learning enables the system to use an algorithm to simulate the relationships between different variables and make predictions based on that simulation. In the context of tasks, this could involve predicting the time required to complete a task, identifying potential bottlenecks, or recommending optimal task sequences. In some instances, machine learning is able to adapt and improve over time as it encounters more data, allowing for continuous refinement of predictions and recommendations.

Method 200 continues with operation 220 of integrating with other components, such as Component 292 (Contextual Environment Analysis), for a comprehensive analysis of the system's context.

Method 200 continues with operation 222 of updating and refining the analysis algorithms to improve the task analysis accuracy and relevance over time. In some instances, operation 222 may be performed in a manner similar to operation 211.

FIG. 2C depicts an example software and hardware identification component 296 of method 200 for obfuscating intelligent data while preserving reserve values. In some embodiments, the example software and hardware identification component 296 is responsible for determining the software and hardware tools available to the system. In some embodiments, the example software and hardware identification component 296 leverages integration with databases and APIs that provide comprehensive information about various software and hardware resources. In some embodiments, the example software and hardware identification component 296 utilizes keyword matching, data retrieval algorithms, and connectivity analysis to identify compatible software and hardware in the system's contextual environment.

Method 200 continues with operation 224 of retrieving information about available software and hardware resources from databases, APIs, or system configurations.

Method 200 continues with operation 226 of collecting metadata about each resource, including compatibility, specifications, and functionalities. In some instances, collecting metadata for resources is valuable for the system to understand the compatibility, specifications, and functionalities for the resources. Metadata may include information such as compatibility with other systems, technical specifications, and the operational capabilities of the resource. For example, in hardware, the metadata may include dimensions, capacity, and processing power, while for software, it may involve features like data analysis or communication capabilities. In another example, for software, version information, dependencies, security details, and lifecycle information may be valuable metadata information.

Method 200 continues with operation 228 of developing a matching algorithm to analyze the system's requirements and compare them with the available resources. In some embodiments, operation 228 identifies the intended goals of the tasks. In some embodiments, operation 228 analyzes the required software and hardware needed to complete the tasks. In some embodiments, operation 228 extracts the required software and hardware specifications. In some embodiments, operation 228 searches for the software and hardware available for the user to access. In some embodiments, operation 228 matches the available resources with the required software and hardware for the user to complete the tasks.

Method 200 continues with operation 230 of determining the suitability and compatibility of each resource based on the analysis. In some embodiments, operation 230 further compares the extracted specifications from the software and hardware with the available resources. In some embodiments, operation 230 can be configured with a tolerance threshold for the accessible success rate. In some embodiments, operation 230 crawls the existing facts that can be found from the available resources to determine the success rate of using such solutions that include the identified software and hardware lists.

Method 200 continues with operation 232 of generating a prioritized list of recommended software and hardware tools that complement the system's existing resources. In some embodiments, operation 232 generates a list of identified software and hardware if it meets the acceptable tolerance threshold. In some embodiments, operation 232 prioritizes the list of software and hardware based on the success rate. In some embodiments, operation 232 can also be configured to prioritize the list based on the price of the items if new software and hardware need to be preached. In some embodiments, operation 232 can also be configured to prioritize the list based on how soon the items can be delivered to the users if the user needs to travel immediately.

Method 200 continues with operation 234 of updating the software and hardware databases to ensure the availability and accuracy of resource information.

FIG. 2D depicts an example tool recommendation component 298 of method 200 for obfuscating intelligent data while preserving reserve values. In some embodiments, the example tool recommendation component 298 utilizes the insights obtained from the contextual environment analysis, task analysis, and software and hardware identification components to provide intelligent recommendations for additional tools. In some embodiments, the example tool recommendation component 298 component takes into account the system's contextual environment, task requirements, and available resources to suggest specific software and hardware tools that complement the existing setup. Machine learning algorithms may be used to analyze historical data and user preferences to personalize recommendations. The recommendations may be presented through an intuitive user interface.

Method 200 continues with operation 236 of receiving inputs from Component 292 (Contextual Environment Analysis), Component 294 (Task Analysis), and Component 296 (Software/Hardware Identification) to understand the system's contextual environment, tasks, and available resources.

Method 200 continues with operation 238 of processing and analyzing the inputs using machine learning algorithms to generate intelligent recommendations for additional tools. In some embodiments, a machine learning algorithm may be designed to assess the data received in operation 236 to predict what additional tools may be needed to complete the scheduled tasks.

Method 200 continues with operation 240 of evaluating factors such as tool compatibility, suitability to tasks, and user preferences during the recommendation process.

Method 200 continues with operation 242 of presenting the recommendations through an intuitive user interface that allows users to review and select the suggested tools. In some instances, the user interface may feature a dashboard that displays a list of recommended tools based on the system's specific needs or preferences. In some embodiments, the suggested tools may be displayed with a description, key features, and/or compatibility with other tools and databases. In some instances, the user interface may have functional options to filter and sort the tools based on user specified criteria such as functionality, compatibility, availability, and/or user rating. In some instances, the interface is designed with search functionality, allowing users to quickly find tools relevant to their requirements. In some embodiments, the interface may incorporate visual elements such as icons or logos to aid quick recognition of tools.

Method 200 continues with operation 244 of providing additional details and information about each recommended tool to assist users in decision-making. In some embodiments, the interface may include a comparison tool or side-by-side view to enable users to evaluate multiple tools simultaneously.

Method 200 continues with operation 246 of improving the recommendation algorithms with user feedback and evaluating the effectiveness of the recommendations.

In some embodiments, the example contextual environment analysis component 292 feeds information to the example task analysis component 294, which in turn communicates with the example software and hardware identification component 296.

The example tool recommendation component 298 incorporates insights from all three components to generate personalized recommendations.

In some embodiments, to implement components 292-298, technologies such as sensors, APIs, data retrieval algorithms, machine learning, natural language processing, and database integration may be utilized.

Artificial neural networks (ANNs) used to train models (e.g., machine learning) can be computing systems modeled after the biological neural networks found in animal brains. Such systems learn (i.e., progressively improve performance) to do tasks by considering examples, generally without task-specific programming. For example, in image recognition, ANNs might learn to identify images that contain cats by analyzing example images that have been manually labeled as “cat” or “no cat” and using the analytic results to identify cats in other images.

In some embodiments of the present disclosure, neural networks may be used to recognize new sources of knowledge. Neural networks may be trained to recognize patterns in input data by a repeated process of propagating training data through the network, identifying output errors, and altering the network to address the output error. Training data may be propagated through the neural network, which recognizes patterns in the training data. Those patterns may be compared to patterns identified in the training data by the human annotators in order to assess the accuracy of the neural network. In some embodiments, mismatches between the patterns identified by a neural network and the patterns identified by human annotators may trigger a review of the neural network architecture to determine the particular neurons in the network that contribute to the mismatch. Those particular neurons may then be updated (e.g., by updating the weights applied to the function at those neurons) in an attempt to reduce the particular neurons' contributions to the mismatch. In some embodiments, random changes are made to update the neurons. This process may be repeated until the number of neurons contributing to the pattern mismatch is slowly reduced, and eventually, the output of the neural network changes as a result. If that new output matches the expected output based on the review by the human annotators, the neural network is said to have been trained on that data.

In some embodiments, once a neural network has been sufficiently trained on training data sets for a particular subject matter, it may be used to detect patterns in analogous sets of live data (i.e., non-training data that has not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter may occur.

In some embodiments, a multilayer perceptron (MLP) is a class of feedforward artificial neural networks. An MLP consists of, at least, three layers of nodes: an input layer, a hidden layer, and an output layer. Except for the input nodes, each node is a neuron that uses a nonlinear activation function. MLP utilizes a supervised learning technique called backpropagation for training. Its multiple layers and non-linear activation distinguish MLP from a linear perceptron. It can distinguish data that is not linearly separable. Also, MLP can be applied to perform regression operations.

However, accurate event prediction for is not possible with traditional neural networks since terms are not listed in ground truth repositories. For example, if a manufacturer of a device has not been previously identified, the neural network may not be able to identify such a manufacturer.

The amount of data that may be necessary for accurate prediction analysis may be sufficiently large for many subject matters that analyzing the data in a reasonable amount of time may be challenging. Further, in many subject matters, large amounts of data may be made available frequently (e.g., daily), and thus data may lose relevance quickly.

In some embodiments, multiple target predictions may be determined by the overall neural network and combined with structured data in order to predict the likelihood of a value at a range of confidence levels. In some embodiments, these neural networks may be any type of neural network. For example, “neural network” may refer to a classifier-type neural network, which may predict the outcome of a variable that has two or more classes (e.g., pass/fail, positive/negative/neutral, or complementary probabilities (e.g., 60% pass, 40% fail)). For example, pass may denote “no maintenance/service needed” and fail may denote “maintenance/service needed.” “Neural network” may also refer to a regression-type neural network, which may have a single output in the form, for example, of a numerical value.

In some embodiments, for example, a neural network in accordance with the present disclosure may be configured to generate a prediction of the probability of a detected network device. This configuration may comprise organizing the component neural networks to feed into one another and training the component neural networks to process data related to the subject matter. In embodiments in which the output of one neural network may be used as the input to a second neural network, the transfer of data from the output of one neural network to the input of another may occur automatically, without user intervention.

As discussed in herein, in some embodiments of the present invention, an aggregate predictor neural network may comprise specialized neural networks that are trained to prepare unstructured and structured data for a new knowledge detection neural network. In some embodiments different data types may require different neural networks, or groups of neural networks, to be prepared for detection of terms.

In some embodiments, the neural network may be a new knowledge detection neural network with one pattern-recognizer pathway (i.e., a pathway of neurons that processes one set of inputs and analyzes those inputs based on recognized patterns, and produces one set of outputs. However, some embodiments may incorporate a new knowledge detection neural network that may comprise multiple pattern-recognizer pathways and multiple sets of inputs. In some of these embodiments, the multiple pattern-recognizer pathways may be separate throughout the first several layers of neurons, but may merge with another pattern-recognizer pathway after several layers. In such embodiments, the multiple inputs may merge as well (e.g., several smaller vectors may merge to create one vector). This merger may increase the ability to identify correlations in the patterns identified among different inputs, as well as eliminate data that does not appear to be relevant.

As used herein, the term “neural network” may refer to an aggregate neural network that comprises multiple sub neural networks, or a sub neural network that is part of a larger neural network. Where multiple neural networks are discussed as somehow dependent upon one another (e.g., where one neural network's outputs provides the inputs for another neural network), those neural networks may be part of a larger, aggregate neural network, or they may be part of separate neural networks that are configured to communicate with one another (e.g., over a local network or over the internet).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system comprising:
a memory storing program instructions; and
a processor in communication with the memory, the processor being configured to execute the program instructions to perform processes comprising:
collecting and analyzing data to determine a contextual environment of the system,
wherein the contextual environment of the system includes existing software and hardware resources available to the system;
employing a matching algorithm to identify additional available software and hardware resources that complement the existing software and hardware resources available to the system;
determining a task to be performed on the system; and
generating a prioritized list of the additional available software and hardware that complement the existing software and hardware resources, the list being ordered based on a degree of relevance with respect to the task to be performed by the system.

2. The system of claim 1, wherein collecting and analyzing data about the contextual environment includes:
collecting data from an environment of the system using sensors and Application Programming Interfaces (APIs); and
pre-processing the collected data to remove noise and irrelevant information.

3. The system of claim 2, wherein collecting and analyzing data about the contextual environment includes:
applying machine learning algorithms to analyze the pre-processed data and extract patterns and insights with respect to the contextual environment.

4. The system of claim 3, wherein collecting and analyzing data about the contextual environment includes:
identifying, based on the extracted patterns and insights with respect to the contextual environment, the existing software and hardware resources available to the system.

5. The system of claim 1, wherein the memory stores further program instructions, and wherein the processor is configured to execute the further program instructions to perform the processes further comprising:
utilizing natural language processing techniques to extract and categorize task-related information associated with the contextual environment, wherein the task-related information includes specific requirement, goals, and constraints associated with the task-related information;
identifying patterns and commonalities among the task based on the task-related information; and
utilizing machine learning with respect to historical task data and the categorized task-related information to determine the task to be performed by the system.

6. The system of claim 1, wherein the memory stores further program instructions, and wherein the processor is configured to execute the further program instructions to perform the processes further comprising:
retrieving information about available software and hardware resources from databases, APIs, and system configurations;
collecting metadata about the additional available software and hardware resources, including resource compatibility, resource specifications, and resource functionalities; and
comparing the collected metadata about the additional available software and hardware resources to the existing software and hardware resources, system resource preferences, and resource relevance with respect to the task to be performed by the system.

7. The system of claim 1, wherein the matching algorithm utilizes keyword matching, data retrieval algorithms, and connectivity analysis to identify compatible software and hardware.

8. A computer-implemented method comprising:
collecting and analyzing data to determine a contextual environment of a system,
wherein the contextual environment of the system includes existing software and hardware resources available to the system;
employing a matching algorithm to identify additional available software and hardware resources that complement the existing software and hardware resources available to the system;
determining a task to be performed on the system; and
generating a prioritized list of the additional available software and hardware that complement the existing software and hardware resources, the list being ordered based on a degree of relevance with respect to the task to be performed by the system.

9. The method of claim 8, wherein collecting and analyzing data about the contextual environment includes:
collecting data from the an environment of the system using sensors and Application Programming Interfaces (APIs); and
pre-processing the collected data to remove noise and irrelevant information.

10. The method of claim 9, wherein collecting and analyzing data about the contextual environment includes:
applying machine learning algorithms to analyze the pre-processed data and extract patterns and insights with respect to the contextual environment.

11. The method of claim 10, wherein collecting and analyzing data about the contextual environment includes:
identifying, based on the extracted patterns and insights with respect to the contextual environment, the existing software and hardware resources available to the system.

12. The method of claim 8, further comprising:
utilizing natural language processing techniques to extract and categorize task-related information associated with the contextual environment, wherein the task-related information includes specific requirement, goals, and constraints associated with the task-related information;
identifying patterns and commonalities among the task based on the task-related information; and
utilizing machine learning with respect to historical task data and the categorized task-related information to determine the task to be performed by the system.

13. The method of claim 8, further comprising:
retrieving information about available software and hardware resources from databases, APIs, and system configurations;
collecting metadata about the additional available software and hardware resources, including resource compatibility, resource specifications, and resource functionalities; and
comparing the collected metadata about the additional available software and hardware resources to the existing software and hardware resources, system resource preferences, and resource relevance with respect to the task to be performed by the system.

14. The method of claim 8, wherein the matching algorithm utilizes keyword matching, data retrieval algorithms, and connectivity analysis to identify compatible software and hardware.

15. A computer program product comprising a computer readable storage medium having program instructions embodied therewith, the program instructions executable by a processor to cause the processor to perform a method, the method comprising:
collecting and analyzing data to determine a contextual environment of a system,
wherein the contextual environment of the system includes existing software and hardware resources available to the system;
employing a matching algorithm to identify additional available software and hardware resources that complement the existing software and hardware resources available to the system;
determining a task to be performed on the system; and
generating a prioritized list of the additional available software and hardware that complement the existing software and hardware resources, the list being ordered based on a degree of relevance with respect to the task to be performed by the system.

16. The computer program product of claim 15, wherein collecting and analyzing data about the contextual environment includes:
collecting data from an environment of the system using sensors and APIs; and
pre-processing the collected data to remove noise and irrelevant information.

17. The computer program product of claim 16, wherein collecting and analyzing data about the contextual environment includes:
applying machine learning algorithms to analyze the pre-processed data and extract patterns and insights with respect to the contextual environment.

18. The computer program product of claim 17, wherein collecting and analyzing data about the contextual environment includes:
identifying, based on the extracted patterns and insights with respect to the contextual environment, the existing software and hardware resources available to the system.

19. The computer program product of claim 15, further comprising additional program instructions stored on the computer readable storage medium and configured to cause the processor to perform the method further comprising:
utilizing natural language processing techniques to extract and categorize task-related information associated with the contextual environment, wherein the task-related information includes specific requirement, goals, and constraints associated with the task-related information;
identifying patterns and commonalities among the task based on the task-related information; and
utilizing machine learning with respect to historical task data and the categorized task-related information to determine the task to be performed by the system.

20. The computer program product of claim 15, further comprising additional program instructions stored on the computer readable storage medium and configured to cause the processor to perform the method further comprising:
retrieving information about available software and hardware resources from databases, APIs, and system configurations;
collecting metadata about the additional available software and hardware resources, including resource compatibility, resource specifications, and resource functionalities; and
comparing the collected metadata about the additional available software and hardware resources to the existing software and hardware resources, system resource preferences, and resource relevance with respect to the task to be performed by the system.
